(19) United States
(12) Patent Application Publication
(10) Pub. No.: US 2014/0085058 A1
(43) Pub. Date: Mar. 27, 2014

(54) METHOD AND READ/WRITE UNIT FOR CONFIGURING A READ/WRITE UNIT IN A RADIO FREQUENCY IDENTIFICATION (RFID) ARRANGEMENT

(71) Applicants: Dieter HORST, Cadolzburg (DE); Joerg Neidig, Nurnberg (DE)

(72) Inventors: Dieter HORST, Cadolzburg (DE); Joerg Neidig, Nurnberg (DE)

(73) Assignee: Siemens Aktiengesellschaft

(21) Appl. No.: 14/035,411

(22) Filed: Sep. 24, 2013

(30) Foreign Application Priority Data
Sep. 27, 2012 (EP) EP12186214

(51) Int. Cl. G06K 7/10

(52) U.S. Cl. CPC G06K 7/10227
USPC 340/10.51

(57) ABSTRACT

A method and read/write unit for configuring read/write units in an RFID arrangement, wherein an operating parameter is adjusted for the configuration in at least one of the read/write units, and direct interchange of messages relating to the configuration occurs between read/write units, where respective wireless interfaces configured for communication by the read/write units with RFID transponders and communication methods and protocols provided for communication with RFID transponders are used for the interchange of the messages, at least one of the read/write units simulates an RFID transponder to another of the read/write units such that read/write units in the complex are configurable without communicating via host interfaces and without separate hardware devices or separate data links between the read/write units, and such that read/write units in the complex without a host interface or unconnected to a data network (e.g., standalone units) can also be configured with one another.

### BACKGROUND OF THE INVENTION

1. Field of the Invention

The invention relates to a method for configuring a read/write unit in a Radio Frequency Identification (RFID) arrangement and to a read/write unit for the RFID arrangement.

2. Description of the Related Art

Read/write units for RFID arrangements, particularly those that operate in the range around 900 MHz (UHF range), essentially have two communication interfaces, i.e., firstly a system interface to a host computer (programmable logic controller, personal computer or other superordinate system), and an “air interface” for communication with RFID transponders. In this case, the read/write units are usually designed such that they execute commands from a host computer, where they communicate with the RFID transponders via the air interface and interchange appropriate useful data (payload) in the process.

In arrangements having a plurality of read/write units, it is frequently necessary for these read/write units to be attuned to one another in terms of their respective configuration. This means that the operating parameters of the read/write units each need to be set such that there is no reciprocal unwanted influencing or reciprocal interference, but it is necessary to ensure that all in all sufficient radio coverage is obtained and the RFID transponders to be detected are detected with sufficient quality (e.g., detection rate, transmission and/or reception powers.

For the purpose of configuring the read/write units, it is customary to connect them to a device, such as a programming unit, via their host interfaces. In the frequent instance of application, in which the host interfaces of the read/write units are connected to a (possibly industrial) data network, the same data network may have a programming unit or the like connected to it that alternately or even simultaneously accesses the operating parameters (parameter sets or configuration file) and allows a user to set the values of the operating parameters as desired.

US 2007/0046467 A1 to Chakraborty et al., entitled “System and Method for RFID Reader to Reader Communication”, discloses an approach in which a plurality of RFID read/write units are attuned to one another such that only one read/write unit is ever permitted to send at the same time, while all other read/write units are in reception mode. In this case, a “Central Authoritative Source” programming unit is provided, where the configuration messages are transmitted from this central programming unit to one of the read/write units and are forwarded by the latter directly to the next read/write unit, etc.

### SUMMARY OF THE INVENTION

In view of the foregoing, it is an object of the present invention to simplify the configuration of read/write units in RFID arrangements and, in so doing, particularly reduce or economize on the devices that are needed for the configuration.

This and other objects and advantages are achieved in accordance with the invention by providing an RFID read/write units that perform the configuration with one another themselves in the complex, where the messages required for this purpose are interchanged directly via the air interface, specifically by using RFID protocols.

It is also an object of the invention to provide a method for configuring a read/write unit in an RFID arrangement having at least two read/write units, where at least one operating parameter is adjusted for the configuration in at least one of the read/write units, and where direct interchange of messages relating to the configuration occurs between the at least two read/write units. Here, the respective wireless interfaces that are configured for communication by the read/write units with RFID transponders and the communication methods and communication protocols that are provided for the communication with RFID transponders are used for the interchange of the messages, at least one of the read/write units simulating an RFID transponder to another of the read/write units. Such a method allows read/write units in the complex to be configured in a manner attuned to one another without the need for communication via the host interfaces and without separate hardware devices or separate data links between the read/write units being necessary. Furthermore, such read/write units in the complex without a host interface or unconnected to a data network (e.g. standalone units) can also be configured with one another.

It is also an object of the invention to provide a read/write unit for an RFID arrangement, where the read/write unit is configured to interchange messages relating to configuration of a read/write unit with a further read/write unit of the RFID arrangement. Here, the read/write unit is configured to interchange the messages via a wireless interface, which is configured for the communication with RFID transponders, using communication methods and communication protocols that are provided for communication with RFID transponders, where the read/write unit is configured to simulate an RFID transponder to the further instance of the read/write units. Such a read/write unit can implement the advantages that have already been discussed in connection with the method in accordance with the invention.

In one advantageous embodiment, the messages interchanged for the configuration relate to the RFID transponders detected at a location or by one of the read/write units and to the radio parameters, i.e., reception field strength (RSSI value) or read rate, which are measured upon detection of the RFID transponders. In a read/write unit that receives these data, these data can be used to decide about changes to operating parameters or for other settings, data obtained locally about the locally received transponders advantageously being able to be used for the comparison. Hence, it is possible, for example, to give the task of processing the data from a detected transponder to that read/write unit for which the transponder has been received with the best quality. To this end, it is possible to inform the other read/write units, by means of messages via the air interfaces, that they can ignore the transponder for the current operating period, or the like. In this case, the changed operating parameters thus relate to the transponders that are to be ignored.

In a further advantageous embodiment, which can be implemented as an alternative or in addition to the other methods and apparatuses described here, the read/write units detect the transmissions by adjacent read/write units and use the radio parameters established or measured in the process, i.e., by way of example, the reception quality or field strengths, etc., to achieve optimum radio coverage for the whole arrangement by suitable adjustment of the transmission powers, radio channels or timeslots. In this case, one of the read/write units in the radio complex can be determined as the “master” for controlling or configuring the other read/write units, for example. This “master” function can also be undertaken by another of the read/write units on a case by case basis. In particular, hierarchies or algorithms are conceivable that permit the master functionality to be “negotiated”. In an alternative embodiment, however, it is also possible for any read/write unit to use the data that it captures itself and to use data that the read/write unit receives from adjacent read/write units to determine or optimize its own radio parameters. Advantageously, each read/write unit may have an administrated piece of information or list about those adjacent read/write units for which a transmission, such as a detection signal (“inventory”), needs to be able to be received at minimum and/or maximum strength. Alternatively, a read/write unit can also determine operating parameters for other read/write units in the complex, can transmit them to the complex and, hence, can determine the behavior of adjacent radio cells.

Examples of operating parameters that can be adjusted are a maximum transmission power or a transmission power that is to be used at present (in future), a radio channel that is to be used or a radio channel that is to be closed, an input sensitivity that is to be used for the reception electronics or else timing parameters. Further operating parameters can specify the communication protocol that is to be used in more detail, as far as both the protocol for reading and writing to the RFID transponders that is used for operative activity is concerned, and the RFID communication protocol that is to be used for communication with other read/write units. Further operating parameters to be adjusted may relate to filter parameters for selecting or rejecting detected RFID transponders. This means that, for example, the messages are used to determine which of the read/write units “processes” which RFID transponders, with groups or identification number ranges also being able to be specified.

A further advantageous instance of use arises when read/write units report the detected transponders onward to adjacent read/write units via the radio interface, the information about the detection of these transponders and possibly captured useful data (payload) being processed further in the read/write units or being reported to an application via a host interface. In this case, it is possible, by way of example, for even such RFID read/write units as have no dedicated host interface or as have difficulty in or no possibility of connecting to a network infrastructure to be incorporated into an industrial arrangement. Besides the identification numbers of the dedicated transponders and the data information (payload) that may be available, it is then advantageously also possible for the identification number or other statements about the detecting read/write unit to be reported, so that it is possible to draw conclusions about the location of the detection, for example.

Finally, one advantageous embodiment of the invention allows the communication via the air interfaces to be used to transmit configuration data from one read/write unit to the other, and to apply them therein, this advantageously being able to be used to facilitate work during the installation of large networks, by virtue of identically configured units being able to be provided. A further appropriate instance of use arises where an existing read/write unit needs to be replaced with another, for example, for maintenance purposes. In this case, manual reconfiguration of the freshly used unit can also be substantially simplified or even dispensed with completely.

Advantageously, the read/write units communicate with one another via modulated backscatter, the role of the respective read/write unit that simulates an RFID transponder being able to change depending on the “direction” of the message transmission.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Exemplary embodiments of the method according to the invention are explained below with reference to the drawings. At the same time, they are used to explain exemplary embodiments of a read/write unit according to the invention, in which:

FIG. 1 shows a schematic illustration of an arrangement comprising four read/write units and an RFID transponder;

FIG. 2 shows an arrangement comprising two read/write units, a computer with an application and an RFID transponder;

FIG. 3 shows a schematic illustration of an arrangement comprising two read/write units and an administration workstation; and

FIG. 4 is a flowchart of the method in accordance with the invention.

### DETAILED DESCRIPTION OF THE PREFERRED EMBODIMENTS

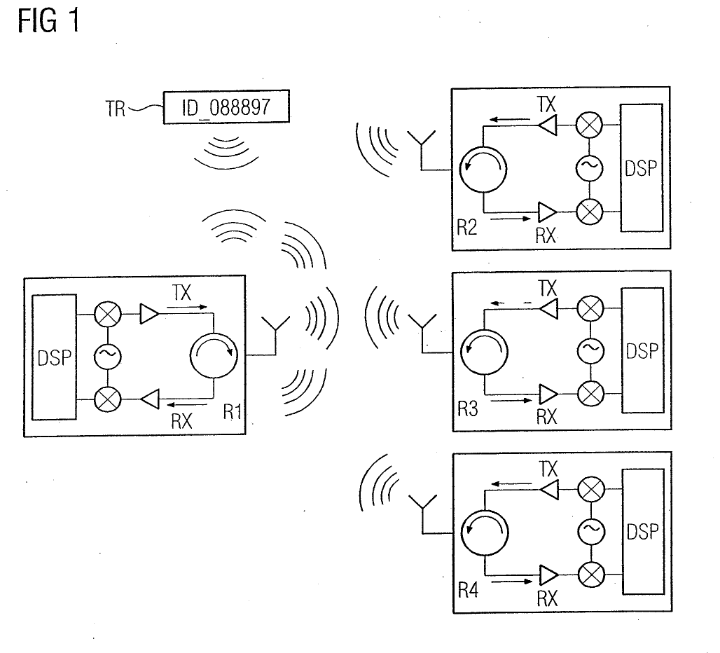

FIG. 1 schematically shows four read/write units R1, R2, R3, R4 that each have a transmission and reception path TX, RX and are equipped with a signal processor DSP. In addition, the figure depicts an RFID transponder TR. Both the RFID transponder TR and the read/write units R1, R2, R3, R4 have unique identification numbers, where the RFID transponder TR has the identification number ID_{—}088897 in the example.

FIG. 1 shows that the read/write units R1, R2, R3, R4 are able both to detect the RFID transponder TR and interchange data therewith and to interchange messages or data with one another using the same air interfaces (antennas, reception circuits, etc.). In this case, a request message (“Inventory”) from a read/write unit R1, R2, R3, R4 can be answered not only by the transponder TR by modulated backscatter but also by the other read/write units R1, R2, R3, R4. Besides the identification numbers (“ID's”), it is also possible for useful contents to be transmitted in this case, i.e., the content of a data memory in the case of the transponder TR, and an arbitrary message in the case of the other read/write units R1, R2, R3, R4, for example.

As an example, it may be assumed that the read/write units R1, R2, R3, R4 are distributed in an industrial environment to cover a relatively large radio area without any gaps. To this end, the transmission power of each read/write unit is meant to be set so high that a modulated carrier wave emitted by this read/write unit will still be received at a minimum reception field strength on all other read/write units R1, R2, R3, R4. On the other hand, the transmission power of each read/write unit R1, R2, R3, R4 needs to be set as low as possible to prevent reciprocal interference. To this end, each of the read/write units R1, R2, R3, R4 can start a respective transmission denoted as a “test signal”, with the other read/write units R1, R2, R3, R4 “backscattering” not only their own respective identification number but also a value for the locally measured reception field strength of the radio signal emitted by the first-named read/write unit R1, R2, R3, R4. The identification numbers of the responding read/write units R1, R2, R3, R4 and the associated field strength values for the reception field strengths (RSSI values) are thus messages that are received via the air interface of the first-named read/write unit R1, R2, R3, R4, according to which these data can be evaluated locally and used for setting the transmission power. This method can be performed by all read/write units R1, R2, R3, R4 in succession, which results in simple but mutually attuned configuration of operating parameters (in this case: transmission power) for the units involved. Besides the transmission power, it should be understood that is possible for numerous other operating parameters to be set, the individual read/write units R1, R2, R3, R4 also being able to use different algorithms for different operating requirements in determining the operating parameters using the received messages.

As an alternative to the method presented here, in which each read/write unit R1, R2, R3, R4 calculates and applies its own parameters, it is also possible for a read/write unit R1, R2, R3, R4 to send an instruction to another of the units, which instruction is used to propose or prescribe a parameter adjustment for this second unit.

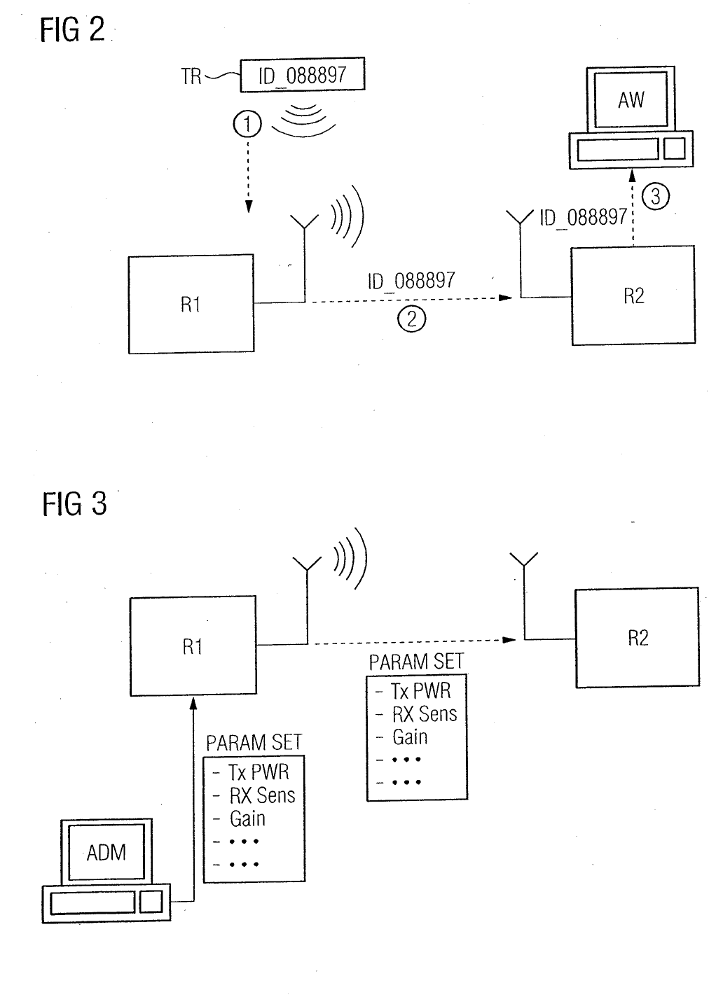

FIG. 2 schematically shows an illustration comprising two read/write units R1, R2, an RFID transponder TR and a personal computer with an application AW. By way of example, the application AW is an industrial control program that needs to be informed about detected RFID transponders TR. For this purpose, the personal computer with the application AW is linked to a host interface of the read/write unit R2, such as via a USB interface or a network connection. An RFID transponder TR that is detected by the read/write unit R1 and that is not in the reception range of the read/write unit R2 is reported to the read/write unit R2 by the read/write unit R1 by a transmission via the air interface. To this end, the read/write unit R1 starts a fresh “inventory”, where the modulated carrier wave contains signaling to indicate that there is a message for the read/write unit R2. This transmission is received and demodulated by the read/write unit R2, after which this unit changes over to a “response mode” and, in a similar manner to an RFID transponder, i.e., in a simulation mode, reports its presence to the read/write unit R1. In a similar manner to the method that is used by a read/write unit to transmit data to a user memory in an RFID transponder, the read/write unit R1 now transmits the serial number and the useful data content of the RFID transponder TR, a piece of time information about the detection time and statistical data (e.g., for example signal-to-noise ratio, timing parameters or field strengths) that have been recorded during the detection of the RFID transponder TR. Depending on requirements in the specific instance of application, this information is reported to the application AW by the read/write unit R2. In a one embodiment, the detection of the RFID transponder TR is in this case reported in the same way as if the read/write unit R2 had detected this transponder TR itself. In an alternative embodiment, however, it is also possible for supplementary information to be transmitted, besides the aforementioned values, particularly also about the transponder TR not having been detected at the location or in the radio area of the read/write unit R2, but rather having been detected by the read/write unit R1 or at the location of the radio area there.

If the transponder TR has been detected on both read/write units R1, R2, it is possible for the read/write unit R2 to perform a comparison to determine the location or the read/write unit R1, R2 at which the transponder TR with the “better” reception properties has been detected. In that case, as location information about the probable whereabouts of the transponder TR, for example, it is possible to indicate that radio cell or that read/write unit R1, R2 for which the “better” reception properties applied. In a case when both read/write units R1, R2 have a host interface, it is also possible to use a respective comparison to stipulate which of the read/write units R1, R2 reports onward or processes the detected transponder TR. In a simple case, it may also apply that the read/write unit R1, R2 at which the transponder TR was detected first is responsible for the further communication with this transponder TR. An appropriate message, provided with the identification number ID_{—}088897, from the read/write unit R1 to the read/write unit R2 would then result in the read/write unit R2 ignoring the transponder TR from that time onward.

Here, the information about RFID transponders that have been detected or that are to be ignored applies as operating parameters in precisely the same way as the aforementioned setting values for transmission power, timing or radio channels, communication protocols.

FIG. 3 again shows an arrangement comprising two read/write units R1, R2, the read/write unit R1 being connected to an administrator workstation ADM. Here, a data record containing configuration information, i.e., containing operating parameters, is transmitted to the read/write unit R1, which transmits these operating parameters to the second read/write unit R2 via the air interface using the aforementioned methods and protocols from RFID communication engineering, after which these operating parameters are applied in the second read/write unit.

In an alternative embodiment, the read/write units R1, R2 can also align their operating parameters with one another without the need to use an administrator workstation ADM.

The illustrated arrangements and the outlined methods can thus be used to implement various use scenarios. Within the context of automatic “channel management”, read/write units R1, R2, R3, R4 are supposed to regulate the use of radio channels, etc. autonomously, i.e., without the compulsory involvement of what is known as a “host”. The reason is that a known problem is that the few (in Europe: four) available radio channels (UHF range) experience a high utilization level given a high density of read/write units R1, R2, R3, R4. The channels used thus need to be chosen such that the units do not interfere with one another. In an automated method in which the read/write units R1, R2, R3, R4 communicate with one another directly via their air interfaces, the units can send one another information about their transmission power and the antenna gain. These values or the messages containing these values can be received by adjacent units, with the path loss being calculated. As a result of the knowledge of radiation power, path losses or interference threshold, it is possible to decide whether or not the same channel can be used without interference. In a third step, the adjacent units are thus used to stipulate a channel use that safely results in interference-free operation of the RFID arrangement. In addition, a central workstation or a “host” can be informed if interference-free operation is not possible, such as on account of a short distance between the units or on account of anomalous propagation. The measurement results for the individual read/write units R1, R2, R3, R4 during the “test transmissions” and also in productive operation can also be made available to a user, such as by an integrated web server.

A further area of use is the targeted avoidance of anomalous prorogation. Particularly in the industrial field, a high density of read/write units R1, R2, R3, R4 can result in anomalous propagation. Owing to the anomalous propagation, RFID transponders TR that are outside the desired detection range are still detected and result in interference or even damage in a production cycle. When data about the correct detections of a preceding read/write unit in the production cycle are transmitted to the subsequent read/write units R1, R2, R3, R4 via the air interface, a list of transponders TR to be expected can be built up. In the case of subsequent discrepancies between the received transponders TR and the entries on this list, algorithms for reacting to anomalous propagation can be applied to adjust the operating parameters of the read/write units R1, R2, R3, R4 involved as appropriate. It is naturally also possible for reports to a user to be output. A further option for handling anomalous propagation has already been discussed briefly, where the radio properties are compared during the communication with a transponder TR in the case of the various detections of the different read/write units R1, R2, R3, R4. To this end, a plurality of read/write units R1, R2, R3, R4 set up radio communication with the same transponder TR. That instance of the read/write units R1, R2, R3, R4 which recognizes the best quality (e.g., RSSI value or stable recognition) during the communication with the relevant transponder TR is located closest to the relevant transponder TR, at least within the context of the radio path. By interchanging this information among one another, the read/write units R1, R2, R3, R4 involved can therefore establish whether or not the transponder TR is an “anomalous propagation”. A third important instance of application has already been described with reference to the transmission of operating parameters from one read/write unit to another and can also be called “reader cloning”. Hence, operating parameters that have been ascertained and confirmed can easily be copied from one unit to the other, particularly when the various reading locations are of the same type of design.

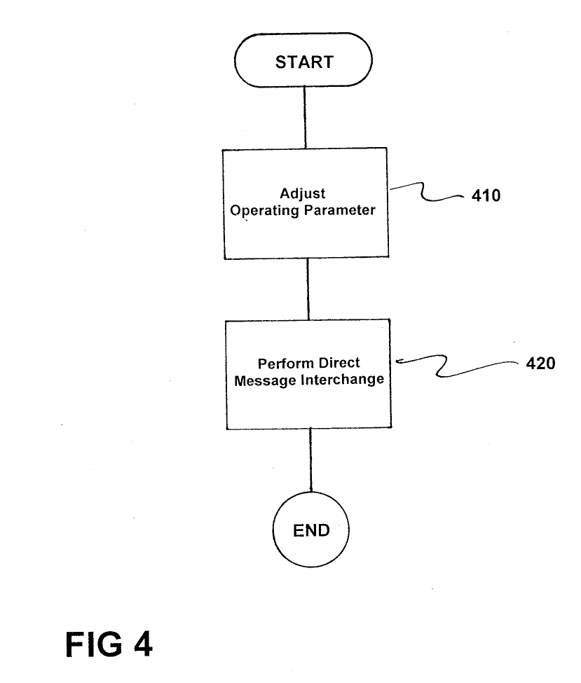

FIG. 4 is a flowchart of a method for configuring a read/write unit in a radio frequency identification (RFID) arrangement having a plurality of read/write units. The method comprises adjusting at least one operating parameter for a configuration in at least one read/write unit of the plurality of read/write units, as indicated in step 410. Next, a direct interchange of messages relating to the configuration is performed between each of the plurality of read/write units, as indicated in step 420. In accordance with the method of the invention, respective wireless interfaces which are set up for communication by each of the plurality of read/write units with RFID transponders and communication methods and communication protocols which are provided for the communication with RFID transponders are used for the interchange of the messages, where at least one of the read/write units simulates an RFID transponder to another RFID transponder of the plurality of read/write units.

While there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for configuring a read/write unit in a radio frequency identification (RFID) arrangement having a plurality of read/write units, the method comprising:
adjusting at least one operating parameter for a configuration in at least one read/write unit of the plurality of read/write units; and
performing a direct interchange of messages relating to the configuration between each of the plurality of read/write units;
wherein respective wireless interfaces which are set up for communication by each of the plurality of read/write units with RFID transponders and communication methods and communication protocols which are provided for the communication with RFID transponders are used for the interchange of the messages, at least one of the read/write units simulating an RFID transponder to another RFID transponder of the plurality of read/write units.

2. The method as claimed in patent claim 1, wherein the configuration of a first read/write unit of the plurality of read/write units comprises utilizing messages to transmit a segment of information identifying at least one of the RFID transponders detected in a radio range of the first read/write unit and data identifying a respective reception quality measured during detection of the RFID transponder or transponders to a second read/write unit of the plurality of read/write units; and
wherein the second read/write unit, when an RFID transponder is detectable within radio range of the plurality of the read/write units, decides which read/write unit of the plurality of read/write units is provided for data interchange with the RFID transponder (TR) or for reporting the RFID transponder to an application (AW) of the RFID arrangement.

3. The method as claimed in claim 2, wherein the decision is respectively performed via a comparison of data relating to a respective RFID transponder and the respective reception quality in radio ranges of at least two of the plurality of read/write units.

4. The method as claimed in claim 1, wherein the configuration comprises a reception quality of a transmission by a second read/write unit of the plurality of read/write units being utilized to adjust at least one operating parameter of at least one read/write unit of the plurality of read/write units, the reception quality being detected by a first read/write unit of the plurality of read/write units.

5. The method as claimed in patent claim 4, wherein an adjusted value for the at least one operating parameter is determined by the first read/write unit of the plurality of read/write units, transmitted to the second read/write unit of the plurality of read/write units via a message and applied in the second read/write unit of the plurality of read/write units.

6. The method as claimed in patent claim 4, wherein data about a detected reception quality are transmitted from the first read/write unit to the second read/write unit of the plurality of read/write units via a message, evaluated by the second read/write unit of the plurality of read/write units and used to one of determine at least one local operating parameter and correct the at least one local operating parameter.

7. The method as claimed in claim 1, wherein the at least one operating parameter to be adjusted which is used comprises at least one of (i) a maximum transmission power, (ii) a transmission power that is to be used, (iii) at least one radio channel that is to be used, (iv) a radio channel that is to be closed, and (v) a reception sensitivity of a receiver.

8. The method as claimed in claim 1, wherein the at least one operating parameter comprises filter parameters for a filter algorithm for one of (i) selecting detected RFID transponders and (ii) rejecting the detected RFID transponders.

9. The method as claimed in claim 1, wherein the messages are used to report at least one RFID transponder detected by a first read/write unit of the plurality of read/write units to a second read/write unit of the plurality of read/write units, the detected at least one RFID transponder being reported onward by the second read/write unit of the plurality of read/write units to an application which is communicatively linked to the second read/write unit.

10. The method as claimed in patent claim 9, wherein the reporting onward of the at least one RFID transponder detected by the first read/write unit by the second read/write unit of the plurality of read/write units comprises reporting onward of a statement identifying a read/write unit of the plurality of read/write units of the RFID arrangement which detected the reported RFID transponder.

11. The method as claimed in claim 1, wherein the messages are utilized to copy at least a plurality of configuration data from a first read/write unit to a second read/write unit of the plurality of read/write units and to apply the plurality of configuration data within the second read/write unit of the plurality of read/write units.

12. A read/write unit for a radio frequency identification (RFID) arrangement, comprising:
a wireless interface configured for communication with RFID transponders;
wherein the read/write unit is configured to interchange messages relating to a configuration of a read/write unit with a further read/write unit of the RFID arrangement; and
wherein the read/write unit is configured to interchange the messages via the wireless interface which utilizing communication methods and communication protocols which are provided for communication with the RFID transponders, the read/write unit being further configured to simulate an RFID transponder to the further read/write unit.

13. The read/write unit as claimed in patent claim 12, wherein the read/write unit is configured to simulate the RFID transponder for modulated backscatter of a modulated carrier signal transmitted by the further instance of the read/write units.
